(19) United States
(12) Patent Application Publication
(10) Pub. No.: US 2022/0075740 A1
(43) Pub. Date: Mar. 10, 2022

(54) PARALLEL PROCESSING ARCHITECTURE WITH BACKGROUND LOADS

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 17/500,990

(22) Filed: Oct. 14, 2021

Related U.S. Application Data
(63) Continuation-in-part of application No. 17/465,949, filed on Sep. 3, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.
(60) Provisional application No. 63/254,557, filed on Oct. 12, 2021.

(51) Int. Cl. G06F 13/16; G06F 13/40

(52) U.S. Cl. CPC G06F 13/1668; G06F 13/4027

(57) ABSTRACT

Techniques for task processing using a parallel processing architecture with background loads are disclosed. A two-dimensional array of compute elements is accessed. Each compute element is known to a compiler and is coupled to its neighboring compute elements. Operation of the array is paused. The pausing occurs while a memory system continues operation. A bus coupling the array is repurposed. The repurposing couples one or more compute elements in the array to the memory system. A memory system operation is enabled during the pausing. Data is transferred from the memory system to the array of compute elements using the bus that was repurposed. The data from the memory system is transferred to scratchpad memory in the one or more compute elements within the two-dimensional array. The scratchpad memory provides operand storage. The data is tagged. The tagging guides the transferring to a particular compute element.

### RELATED APPLICATIONS

This application claims the benefit of U.S. provisional patent applications “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

This application is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a parallel processing architecture with background loads.

### BACKGROUND

Organizations including businesses, governments, hospitals, universities, research laboratories, retail establishments, and others process large amounts of data as part of their routine operations. Since the introduction of the first electronic computers, enterprises large and small have relied on those computers to process myriad data processing tasks. Yet, the success or failure of a given organization is directly dependent on whether their data can be processed to the benefit of the organization in a timely and cost-effective manner. The data is aggregated into large collections of data, commonly referred to as datasets. The datasets can be processed using various techniques that support a given organization. The processing of the datasets has become so essential that the success or failure of an organization is inextricably linked to whether the data can be processed to organizational advantage. When the data processing is beneficial or advantageous to the organization, and can be performed economically, the organization thrives. If the data processing is inefficient or ineffective, then the organization can find itself in great peril.

Organizations devote vast financial and other resources annually to support their many and varied data processing requirements. The requirements include collecting, storing, analyzing, processing, securing, and backing up data, among other tasks. Some organizations store their data in-house, and maintain their own processing facilities for asset management, physical security, etc. Other organizations choose to contract with cloud-based computational facilities that offer secure data storage and backup, and access to processing hardware and software. These cloud-based data handling and processing facilities can provide multiple datacenters distributed across large geographic areas. The cloud-based option provides computation, data collection, data storage, and other needs, “as a service”. These services support data processing and handling access to organizations that would otherwise be unable or unwilling to equip, staff, and maintain their own datacenters. Whether supported in-house or contracted with cloud-based services, the organizations operate based on data processing.

Data is collected from a wide and diverse range of individuals using many and varied data collection techniques. The individuals usually include citizens, clients, patients, purchasers, students, test subjects, and volunteers. Sometimes the individuals are willing participants, while at other times they are unwitting subjects or even victims of pernicious data collection. Legitimate data collection strategies include “opt-in” techniques, where an individual signs up, registers, creates a user ID or account, or otherwise consciously and willingly agrees to participate in the data collection. Other techniques are mandated, such as a government or agency requiring citizens to obtain a registration number and to use that number while interacting with governments or agencies, law enforcement, emergency services, among others. Further data collection techniques are more subtle or intentionally obscured, including tracking purchase histories, website visits, button clicks, and menu choices. No matter the techniques used for the data collection, the collected data is highly valuable to the organizations that collected it. By whatever means collected, the rapid processing of this data remains critical.

### SUMMARY

Organizations large and small execute substantial numbers of processing jobs as part of their normal operations. The processing jobs, whether running payroll, invoicing customers, analyzing customer data, or training a neural network for machine learning, among many others, are composed of multiple tasks. The processing tasks are often based on common operations such as accessing datasets, accessing processing components and systems, accessing communications channels, and so on. The tasks, which can be quite complex, can be based on subtasks, where the subtasks can be used to handle loading or reading data from storage, performing computations on the data, storing or writing the data back to storage, handling inter-subtask communication, handling processing and data exceptions, etc. The datasets that are accessed can be immense, including terabytes of data, petabytes of data, or more. These large datasets can easily saturate processing architectures that are poorly matched to the processing tasks or are based on inflexible architectures. Task processing efficiency and data throughput are significantly improved by using two-dimensional (2D) arrays of processing elements. The array of elements can be configured to efficiently process a wide variety of tasks, subtasks, and so on. The arrays include 2D arrays of compute elements, multiplier elements, scratchpad memories, caches, queues, controllers, decompressors, and other components. The caches associated with the 2D arrays can multilevel caches. The 2D arrays are configured and operated by providing compiled code to control the various elements within the array. The compiled code is generated by compiling the processing tasks. The processing tasks can be associated with complex and data-intensive processing applications such as audio and image processing applications, machine learning functionality, neural network implementations, and so on. The data can further include operations that are provided to the array. The provided data is processed by the arrays to perform processing tasks such as data analysis. The arrays of elements can be configured to implement a flow diagram, an architecture, and the like. The arrays can be further configured in a topology that is best suited to the task processing. The topologies into which the arrays can be configured include a systolic, a vector, a cyclic, a spatial, a streaming, or a Very Long Instruction Word (VLIW) topology.

Task processing is based on a parallel processing architecture with background loads. A processor-implemented method for task processing is disclosed comprising: accessing a two-dimensional (2D) array of compute elements, wherein each compute element within the array of compute elements is known to a compiler and is coupled to its neighboring compute elements within the array of compute elements; pausing operation of the array of compute elements, wherein the pausing occurs while a memory system continues operation; repurposing a bus coupling the array of compute elements, wherein the repurposing couples one or more compute elements in the array of compute elements to the memory system, and wherein a memory system operation is enabled during the pausing; and transferring data from the memory system to the array of compute elements, using the bus that was repurposed. In embodiments, the data from the memory system is transferred to scratchpad memory in one or more compute elements within the two-dimensional array. The scratchpad memory can include a register or register file, a cache, etc., that can be coupled to a compute element. The scratchpad memory can be used for storing operands, intermediate results, results, base addresses, immediates, loop variables, and the like. The scratchpad memory enables high speed, local access to data for processing. Embodiments include tagging the data before it is transferred. The tagging guides the transferring to a particular compute element within the array of compute elements. The particular compute element can be identified by a column and a target row location. In embodiments, load queues are coupled between the memory system and the bus. The load queues buffer the transferring data from the memory system. The load queues are notified of the pausing, where the pausing operation is necessitated by an exception or data congestion. In embodiments, the load queues are emptied of the data that was buffered before a resume occurs. The pausing, the repurposing, and the transferring comprise a background data load.

In embodiments, the compiler schedules computation in the array of compute elements. The scheduling can include configuring the array of compute elements, where the configuring can include assigning caches to particular compute elements, configuring communications paths, and so on. The scheduling computation within the array can include providing compiled code, microcode, etc., to a compute element for task processing. In embodiments, the computation includes compute element placement, results routing, and computation wave front propagation within the array of compute elements. The scheduling computation can be based on compiled tasks and compiled subtasks associated with the tasks. In embodiments, a compiled task can include multiple programming loop instances circulating within the array of compute elements. The multiple programming loop instances can enable parallel processing. The configuring of the compute elements by the compiler can enable processing topologies, architectures, and so on. In other embodiments, the array of compute elements comprises a superstatic processor architecture.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a parallel processing architecture with background loads.

FIG. 2 is a flow diagram for data tagging.

FIG. 3 shows a system block diagram for a highly parallel architecture with a shallow pipeline.

FIG. 4 shows compute element array detail.

FIG. 5 illustrates background loads.

FIG. 6 shows virtual single cycle load latency.

FIG. 7 illustrates logic for control background loads.

FIG. 8 is a system diagram for a parallel processing architecture with background loads.

### DETAILED DESCRIPTION

Techniques for data manipulation using a parallel processing architecture with background loads are disclosed. The tasks that are processed can perform a variety of operations including arithmetic operations, shift or rotate operations, logical operations including Boolean operations, vector or matrix operations, and the like. The tasks can include a plurality of subtasks. The subtasks can be processed based on precedence, priority, coding order, amount of parallelization, data flow, data availability, compute element availability, communication channel availability, and so on. The data manipulations are performed on a two-dimensional array of compute elements. The compute elements, which can include CPUs, GPUs, ASICs, FPGAs, cores, and other processing components, can be coupled to local storage, which can include memory such as a scratchpad memory. The scratchpad memory can be used for storing data including unsigned or integer data, real or float data, characters, vectors or matrices, etc. The data that is stored in the scratchpad memory can include operand data that is provided to, operated on, generated by, etc., the compute elements. The data can be transferred from a memory system, local or remote storage, and so on, using background loads. The background loads accomplish the data transfer while the array of compute elements is paused. The background loads can enable efficient transfers of data from the memory system or storage to the compute elements by enabling one or more background transfers to occur at substantially the same time. The background loads also simplify array control requirements because the one or more data transfers can occur within a virtual cycle.

The tasks, subtasks, etc., are compiled by a complier. The compiler can include a general-purpose compiler, a hardware description-based compiler, a compiler written or “tuned” for the array of compute elements, a constraint-based compiler, a satisfiability-based compiler (SAT solver), and so on. The compiler can generate a stream of control words, such as microcode control words, which can control the compute elements within the array. The control words can also enable background loads of data by pausing operation of the array of compute elements. Pausing the compute elements is distinct from idling one or more compute elements. While idling one or more compute elements can be performed when the compute elements are not needed at a particular point for task processing, pausing operation of the array can suspend computations being performed by the compute elements. Further, portions of the array, and in particular a bus that couples the array of compute elements to a memory system, can continue operation. Thus, the bus can be used to perform “background loads”, where a background load can include handing one or more memory access requests at substantially the same time by executing the access requests and providing the requested data to the appropriate compute elements.

A highly parallel architecture with a background load enables task processing. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Operation of the array of compute elements is paused. The pausing the compute elements can include recording a state of the compute elements and other elements within the array and suspending processing by the compute elements. While the compute elements can be paused, other components within the array can continue operation. The pausing occurs while a memory system continues operation. A bus coupling the array of compute elements to the memory system for operation is repurposed during the pausing. The repurposing can include accessing the bus so that access requests by one or more compute elements, or access requests generated by compiler code based on the task processing, can be handled. Handling the access requests includes accessing storage such as the memory system and providing the data associated with the access requests. Data from the memory system is transferred to the array of compute elements using the bus that was repurposed. The data can be tagged, where the tagging guides the data that is being transferred to a particular compute element within the array of compute elements. The transferring the data enables the background loads. Operation of the array of compute elements is resumed after the transferring data is complete. The resuming operation can include restoring the state of the compute elements prior to the pausing of the operation of the compute elements. The resuming operation can be accomplished under compiler control.

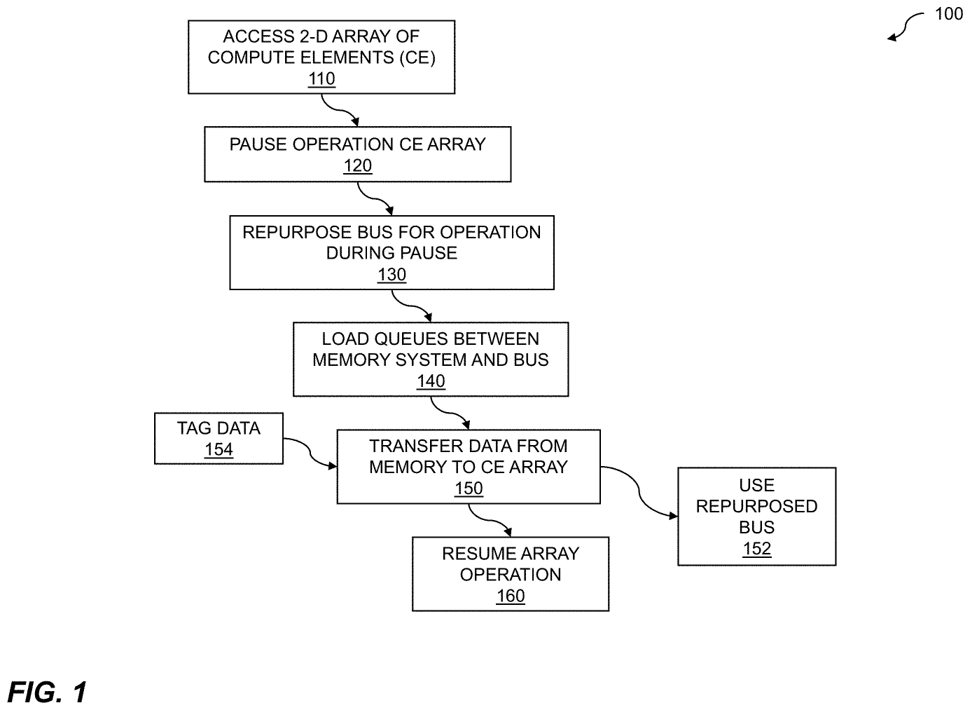

FIG. 1 is a flow diagram for a parallel processing architecture with background loads. Clusters of compute elements (CEs), such as CEs assembled within a 2D array of CEs, can be configured to process a variety of tasks. The tasks can be based on a plurality of subtasks. The tasks can accomplish a range of processing objectives such as data manipulation, application processing, machine learning, and so on. The tasks can operate on a diversity of data types including integer, real, and character data types; vectors and matrices; data structures; etc. The array of compute elements can be controlled based on control words such as microcode control words generated by a compiler. The control words enable or idle various compute elements; provide data; route results between or among CEs, scratchpad memories, a memory system or storage; and the like. The control words can pause operation of the array of compute elements to enable background loads of data from the memory system to load queues, scratchpad memories, etc. The background loading occurs within a virtual single compiler cycle, thus simplifying control of the array of compute elements. The background loads are enabled by repurposing a bus coupling the array of compute elements to the memory system, and transferring data from the memory system to the array of compute elements, using the repurposed bus.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements, or CEs, can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can be configured in a topology. A topology can be built into the array, programmed or configured within the array, etc. In embodiments, the array of compute elements can be configured by one or more control words generated by the compiler. The topology into which the array is configured can include a systolic, a vector, a cyclic, a spatial, a streaming, or a Very Long Instruction Word (VLIW) topology. In addition to configuring the array of compute elements, the compiler schedules computation in the array of compute elements. The scheduling can include assigning high priority tasks ahead of low priority tasks, scheduling execution order of tasks with data dependencies, and the like. In further embodiments, the computation can include compute element placement, results routing, and computation wave front propagation within the array of compute elements. The placement and propagation can be based on array usage efficiency, data propagation time minimization, heat dissipation requirements, etc. In embodiments, a compiled task includes multiple programming loop instances circulating within the array of compute elements. The multiple programming loop instances can enable parallel processing of data. In other embodiments, the array of compute elements comprises a superstatic processor architecture. In a superstatic processor architecture, the placement in the array, the routing of results and routing of execution wave front propagation, and the scheduling of computation are all performed by the compiler, not by an underlying instruction-driven hardware microarchitecture at runtime. In a superstatic architecture, pipelining registers are part of the architectural state that the compiler targets. A superstatic processor architecture can include various components such as input and output components; a main memory; and a CPU that includes a control unit and a processor. The processor can further include registers and combinational logic.

The compute elements can be configured based on a compiled task. In embodiments, the compiled task comprises machine learning functionality. The machine learning functionality can include deep learning functionality. Machine learning functionality can be applied to a wide variety of applications including image analysis, facial recognition, audio analysis, voice recognition, medical image analysis, disease analysis and detection, speech to text conversion, speech or text translation, and so on. In embodiments, the machine learning functionality can include neural network implementation. The neural network implementation can be based on various neural network techniques such as convolutional neural networks, recurrent neural networks, etc. The compute elements can be coupled to other elements within the array of CEs. In embodiments, the coupling of the compute elements can enable one or more topologies. The other elements to which the CEs can be coupled can include storage elements such as scratchpad memories; multiplier units; address generator units for generating load (LD) and store (ST) addresses; load queues; and so on. The compiler to which each compute element is known can include a general-purpose compiler such as a C, C++, or Python compiler; a hardware-oriented compiler such as a VHDL or Verilog compiler; a compiler written for the array of compute elements; and so on. The coupling of each CE to it neighboring CEs enables communication between or among neighboring CEs and the like.

The flow 100 includes pausing operation of the array of compute elements 120, wherein the pausing occurs while a memory system continues operation. Pausing operation of the array of CEs can include preserving a state of the array of CEs so that operation of the array of CEs can be resumed. Pausing operation of the array of CEs is different from idling the CEs. While idling one or more CEs can occur when the one or more CEs are not required for a particular processing task, pausing the CEs enables other operations such as data transfer (discussed below) to continue while the array is paused. The pausing of the array of CEs can result from a variety of conditions, events, etc. associated with the operation of one or more compute elements or with the array. In embodiments, the pausing operation can be necessitated by an exception. An exception can occur during task processing of one or more tasks on compute elements within the array. An exception can be based on a processing exception or anomaly such as when needed data is not available when a task is executed or processed. An exception can generate an interrupt, a flag, a condition, etc. In other embodiments, the pausing operation can be necessitated by data congestion. Data congestion can occur at a memory system when a plurality of compute elements is requesting data accesses substantially simultaneously; on a bus such as a ring bus associated with a column or a row of compute elements within the array of compute elements; and so on. In embodiments, the data congestion can be due to access jitter or a data cache miss. Access jitter can include a difference in an amount of time associated with the arrival of data at a compute element, a load buffer, and the like.

The flow 100 further includes repurposing a bus 130 coupling the array of compute elements to the memory system for operation during the pausing. The bus can include a bus within the 2D array of compute elements, a bus coupling the array and the memory system, a bus used to couple one or more integrated circuits such as an inter-integrated circuit (I²C) bus, and the like. In embodiments, the bus can include a ring bus along a row or column of the array of compute elements. Another bus configuration can include a bus along a diagonal, a “vertical” bus for stacked arrays of compute elements, etc. In embodiments, the bus continues operation during the pausing. The continued operation of the bus enables bus operations, such as data transfers, to occur between compute elements, the array of compute elements and the memory system, etc.

The flow 100 further includes load queues coupled between the memory system and the bus 140. The load queues can include small memories, registers, register files, first in first out (FIFO) components, and so on. The load queues can be used to hold data such as operands that can be retrieved from the memory system, storage, etc. In embodiments, the load queues can be notified of the pausing. Notification to the load queues about the pausing can be used to enable emptying of the queues prior to receiving data from the memory system or other storage; to reset the load queues, etc. In further embodiments, the load queues participate in the repurposing. The load queues can be used for enabling background loads to be transferred to scratchpad memories associated with one or more compute elements.

The flow 100 includes transferring data 150 from the memory system to the array of compute elements. The transferring data can include transferring compiled tasks, commands, data to be processed, operands, and so on. In embodiments, the pausing, the repurposing, and the transferring can include a background data load. In the flow 100, the transferring data is enabled using the repurposed bus 152. The transferring can take place using a standard bus technique such as a PCI or PCIe bus, SCSI bus, and so on. The transferring can take place using a network such as an Ethernet™ network, an 802.11 Wi-Fi network, etc. In embodiments, the data from the memory system can be transferred to a scratchpad memory in one or more compute elements within the two-dimensional array. The scratchpad memory can include a storage component collocated with or adjacent to one or more compute elements. The scratchpad memory can be used to store a variety of types of data including integers, reals or floats, characters, etc. In embodiments, the scratchpad memory can provide operand storage. The operands in the scratchpad memory can be operated on by compiled code executed by one or more compute engines. The transferring of the data can be simplified and made more efficient by identifying a target compute element, scratchpad memory, or the like. The flow 100 includes tagging the data 154 before it is transferred. The tagging can include adding an address, a code, a bit, a flag, an identifier, a target, and so on. In embodiments, the tagging can guide the transferring to a particular compute element within the array of compute elements. A compute element can be identified by the array column in which the CE is located and by an intersecting row. In embodiments, the tagging comprises a target row location within the array of compute elements.

The flow 100 includes resuming operation of the array 160 of compute elements after the transferring data is complete. The resuming operation can include returning to processing of data, operands, and so on using the compute elements. The resuming operation can be based on restoring a state of the array of compute elements to the state which existed prior to pausing of the array. In embodiments, a compiled task can determine the resuming operation. Recall that data can be transferred using a background load technique in which data is transferred to compute elements within the array while the array is paused. In embodiments, the load queues can be emptied of the data that was buffered before a resume occurs. That is, data transfer resulting from one or more background loads can be completed before resuming operation by the array. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

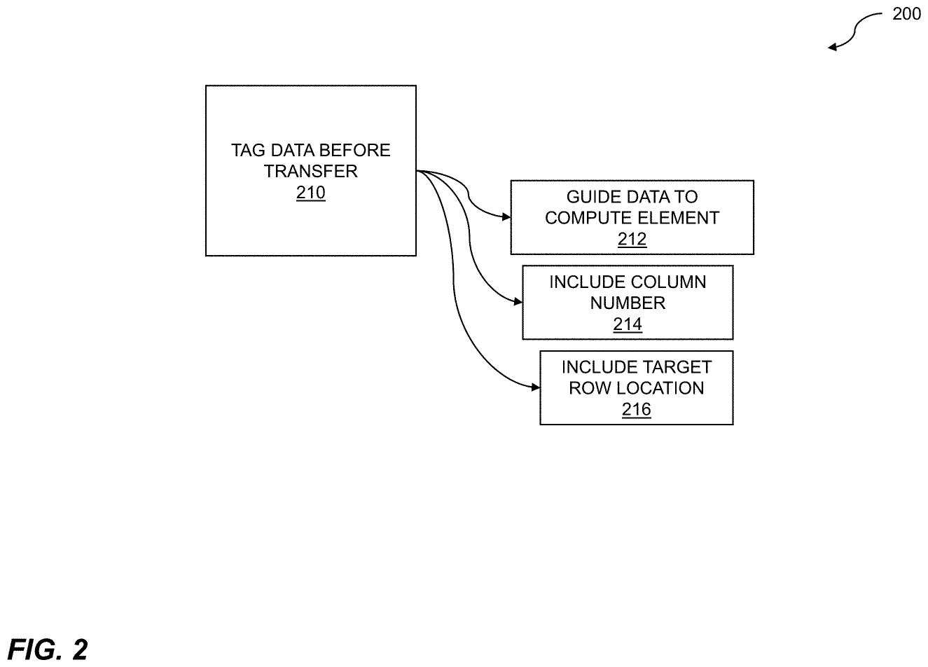

FIG. 2 is a flow diagram for data tagging. Discussed throughout, tasks can be processed on an array of compute elements. The tasks can include general operations such as arithmetic, vector, or matrix operations; operations based on applications such as neural network or deep learning operations; and so on. In order for the tasks to be processed correctly, the tasks must be scheduled on the array of compute elements, and data must be accessed that will be operated on by the tasks. The data can be provided to the tasks by using background loads. The background loads can transfer data to compute elements from load queues, from a memory system, from local or remote storage, etc. Since the data that is loaded can be intended for one or more compute elements within the array of compute elements, the data can be tagged. The data tagging enables a parallel processing architecture with background loads. A two-dimensional (2D) array of compute elements is accessed, wherein each compute element within the array of compute elements is known to a compiler and is coupled to its neighboring compute elements within the array of compute elements. Operation of the array of compute elements is paused, wherein the pausing occurs while a memory system continues operation. A bus coupling the array of compute elements to the memory system is repurposed for operation during the pausing. Data is transferred from the memory system to the array of compute elements, using the bus that was repurposed.

The flow 200 includes tagging the data 210 before it is transferred. Transferring data includes obtaining data from a source such as a memory system, local or remote storage, load queues, and so on, and writing the data to a scratchpad memory associated with a compute element. Each compute element is in communication with its nearest neighbors, where the communication with the neighbors can occur along rows and columns of the 2D array of compute elements. Thus, data that is intended for a specific compute element within the array must be directed to the column within which the targeted compute element is located as well as its row location. The directing of the data to a compute element can be accomplished by tagging the data. The tagging can include a flag, an address, a code, an ID, and so on. The tagging can be accomplished by the compiler, by a compute element requesting access to storage, and the like. The tag associated with the data can include one or more bits. In embodiments, the tagging comprises a 5-bit tag. In the flow 200, the tagging guides 212 the transferring the data to a particular compute element within the array of compute elements. The guiding can be based on including a column number 214 of a compute element that requested access and can be accomplished by examining the tag to determine the column number. In the flow 200, the tagging comprises a target row location 216 within the column of the array of compute elements. Recall that access to the compute elements of the 2D array of compute elements can be accomplished at the edges of the 2D array. Thus, requested data can access a column of the array by providing the data at the top or bottom of the array. The data can be provided to a column of the array by providing the data to a ring bus along the column of the array. The compute element to which the data is to be provided can be determined by examining the tag bits to determine a row for the compute element. The intersection of the row, based on the tag bits, and the column to which the data is provided, determines the compute element to which the data is being transferred. The data can be written into a scratchpad memory associated with the compute element at the intersection of the column and row. The scratchpad memory can be accessible to one compute element directly and other compute elements indirectly. In embodiments, the scratchpad memory can include a dual read, single write (2R1 W) scratchpad memory. That is, the 2R1 W scratchpad memory can enable two contemporaneous read operations and one write operation without the read and write operations interfering with one another.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

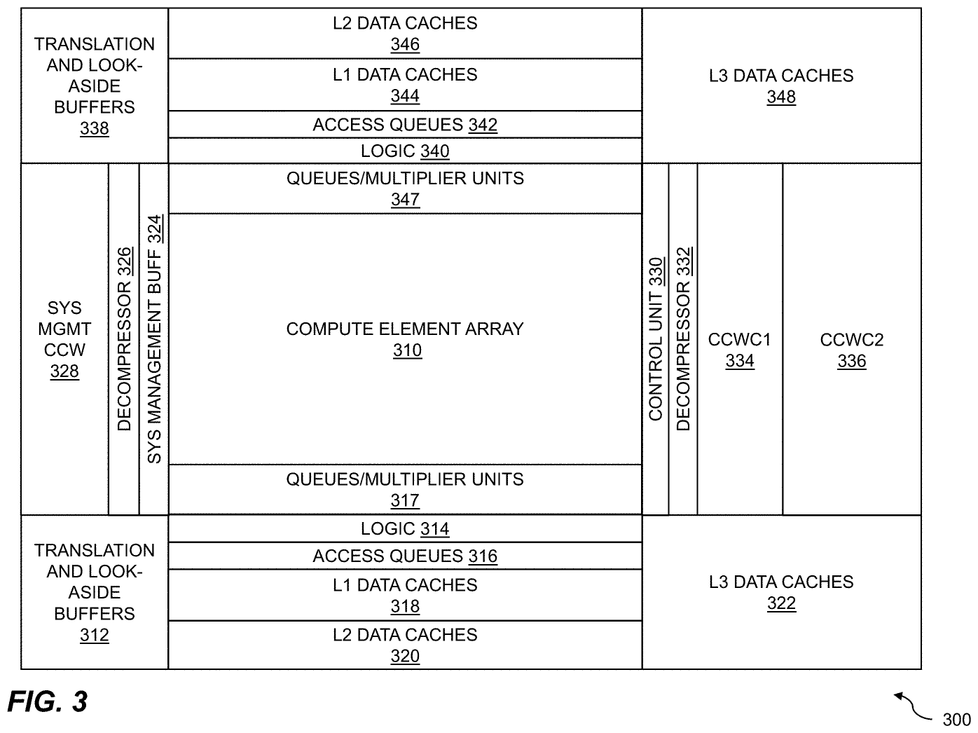

FIG. 3 illustrates a system block diagram for a highly parallel architecture with a shallow pipeline. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The task processing is enabled using a parallel processing architecture with distributed register files. A two-dimensional (2D) array of compute elements is accessed, wherein each compute element within the array of compute elements is known to a compiler and is coupled to its neighboring compute elements within the array of compute elements. Operation of the array of compute elements is paused, wherein the pausing occurs while a memory system continues operation. A bus coupling the array of compute elements is repurposed, wherein the repurposing couples one or more compute elements in the array of compute elements to the memory system, and wherein a memory system operation is enabled during the pausing. Data is transferred from the memory system to the array of compute elements, using the bus that was repurposed.

A system block diagram 300 for a highly parallel architecture with a shallow pipeline is shown. The system block diagram can include a compute element array 310. The compute element array 310 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 300 can include translation and look-aside buffers such as translation and look-aside buffers 312 and 338. The translation and look-aside buffers can comprise memory caches, where the memory caches can be used to reduce storage access times. The system block diagram can include logic for load and access order and selection. The logic for load and access order and selection can include logic 314 and logic 340. Logic 314 and 340 can accomplish load and access order and selection for the lower data block (316, 318, and 320) and the upper data block (342, 344, and 346), respectively. This layout technique can double access bandwidth, reduce interconnect complexity, and so on. Logic 340 can be coupled to compute element array 310 through the queues, address generators, and multiplier units 347 component. In the same way, logic 314 can be coupled to compute element array 310 through the queues, address generators, and multiplier units 317 component.

The system block diagram can include access queues. The access queues can include access queues 316 and 342. The access queues can be used to queue requests to access caches, storage, and so on, for storing data and loading data. The system block diagram can include level 1 (L1) data caches such as L1 caches 318 and 344. The L1 caches can be used to store blocks of data such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 320 and 346. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 322 and 348. The L3 caches can be larger than the L1 and L2 caches and can include slower storage. Accessing data from L3 caches is still faster than accessing main storage. In embodiments, the L1, L2, and L3 caches can include 4-way set associative caches.

The block diagram 300 can include a system management buffer 324. The system management buffer can be used to store system management codes or control words that can be used to control the array 310 of compute elements. The system management buffer can be employed for holding opcodes, codes, routines, functions, etc. which can be used for exception or error handling, management of the parallel architecture for processing tasks, and so on. The system management buffer can be coupled to a decompressor 326. The decompressor can be used to decompress system management compressed control words (CCWs) from system management compressed control word buffer 328 and can store the decompressed system management control words in the system management buffer 324. The compressed system management control words can require less storage than the uncompressed control words. The system management CCW component 328 can also include a spill buffer. The spill buffer can comprise a large static random-access memory (SRAM) which can be used to support multiple nested levels of exceptions.

The compute elements within the array of compute elements can be controlled by a control unit such as control unit 330. While the compiler, through the control word, controls the individual elements, the control unit can pause the array to ensure that new control words are not driven into the array. The control unit can receive a decompressed control word from a decompressor 332. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 334. CCWC1 can include a cache such as an L1 cache that includes one or more compressed control words. CCWC1 can be coupled to a further compressed control word store such as compressed control word cache 2 (CCWC2) 336. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 332 can be coupled between CCWC1 334 (now DCWC1) and CCWC2 336.

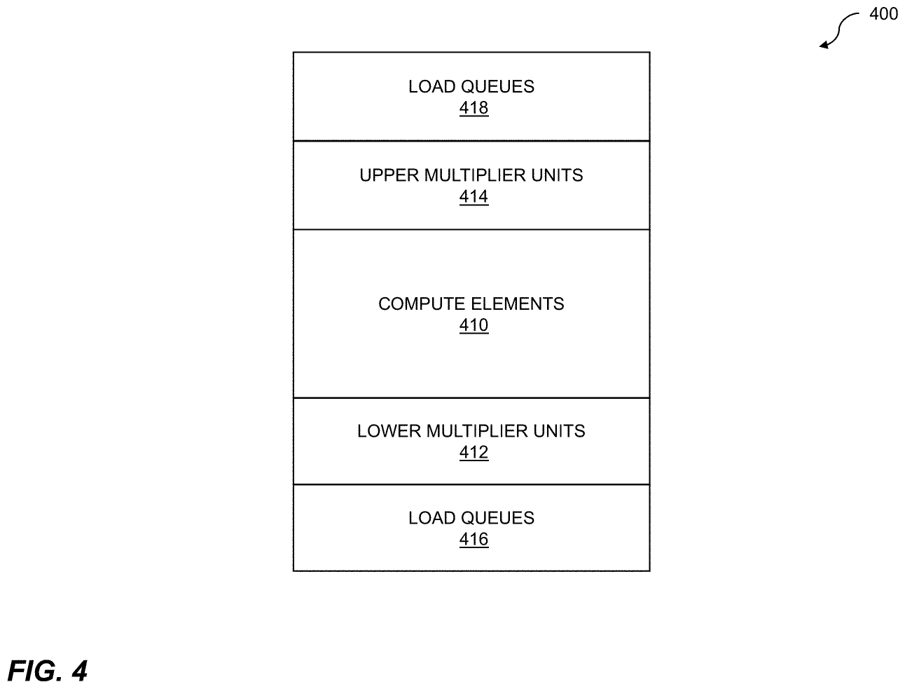

FIG. 4 shows compute element array detail 400. A compute element array can be coupled to components which enable the compute elements to process one or more tasks, subtasks, and so on. The components can access and provide data, perform specific high-speed operations, and the like. The compute element array and its associated components enable a parallel processing architecture with background loads. The compute element array 410 can perform a variety of processing tasks, where the processing tasks can include operations such as arithmetic, vector, matrix, or tensor operations; audio and video processing operations; neural network operations; etc. The compute elements can be coupled to multiplier units such as lower multiplier units 412 and upper multiplier units 414. The multiplier units can be used to perform high-speed multiplications associated with general processing tasks, multiplications associated with neural networks such as deep learning networks, multiplications associated with vector operations, and the like. The compute elements can be coupled to load queues such as load queues 416 and load queues 418. The load queues can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

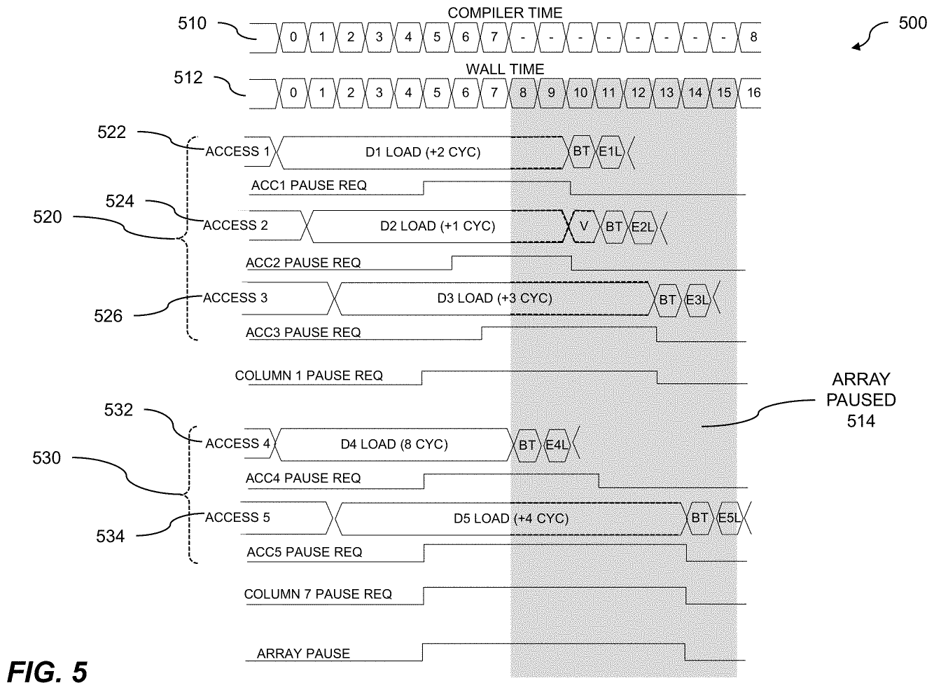

FIG. 5 illustrates background loads 500. Discussed throughout, compute elements within a 2D array of compute elements can be paused so that data can be transferred using a background load technique. The background load technique can be used to transfer data based on an occurrence of an exception such as an interrupt, data congestion attributable to access jitter such as memory system access jitter, and so on. The background loads enable a parallel processing architecture. A two-dimensional (2D) array of compute elements is accessed. Each compute element within the array of compute elements is known to a compiler and is coupled to its neighboring compute elements. Operation of the array is paused, where the pausing occurs while a memory system continues operation. A bus coupling the array of compute elements is repurposed, where the repurposing couples one or more compute elements in the array to the memory system, and where a memory system operation is enabled during the pausing. Data is transferred from the memory system to the array of compute elements, using the repurposed bus.

A background load can be initiated by a compiler, where the compiler provides a signal to one or more load queues that indicates that one or more background loads will be performed when a load request is issued from the 2D array of compute elements. The background loads can provide data to one or more compute elements within the 2D array, where the compute elements can be located within one or more columns and rows within the array. Loads, which can include scheduled loads or background loads, can transfer data to one or more scratchpad memories associated with the compute elements within the array. The loading, whether a scheduled load or a background load, can be controlled based on compiler time 510 and on “wall” time 512. Compiler time can include compiler clock ticks, processing cycles, etc., originating the compiler. Wall time, which can include system clock ticks, system processing cycles, and the like, can occur continuously. That is, while the compiler time can suspend during the array being paused, wall time can proceed. Using this technique, background loads can appear to occur during a single, virtual compiler cycle, while the actual accessing of load queues, a memory system, etc., can be performed under wall time.

The FIG. 500 illustrates five loads, such as background loads, that can occur while the 2D array can be paused. The array can be paused 514 by the compiler, and the compiler can indicate that the loads are background loads. The array can also be paused based on a column request (discussed elsewhere). The loads, which can include access to load queues, to a memory system, to storage, etc., can be associated with providing data to compute elements within a column such as column 1 520. The accesses that can originate within column 1 can include access 1 522, access 2 524, access 3 526, and so on. The accesses 1, 2, and 3 can be offset by one or more cycles, where the cycles can be based on compiler time. The accesses can also be associated with a second or further column such as column 7 530. The accesses that originate within column 7 can include access 4 532 and access 5 534. The accesses 4 and 5 can also be offset. When the 2D array of compute elements is paused, the accesses can be performed. The accesses to load queues, the memory system, etc., can be performed based on wall time. Since compiler time suspends while the array is paused, as opposed to wall time that never stops, the accesses occur within one virtual compiler clock tick or cycle. When the accesses are complete, the array can be resumed, and compile time can continue.

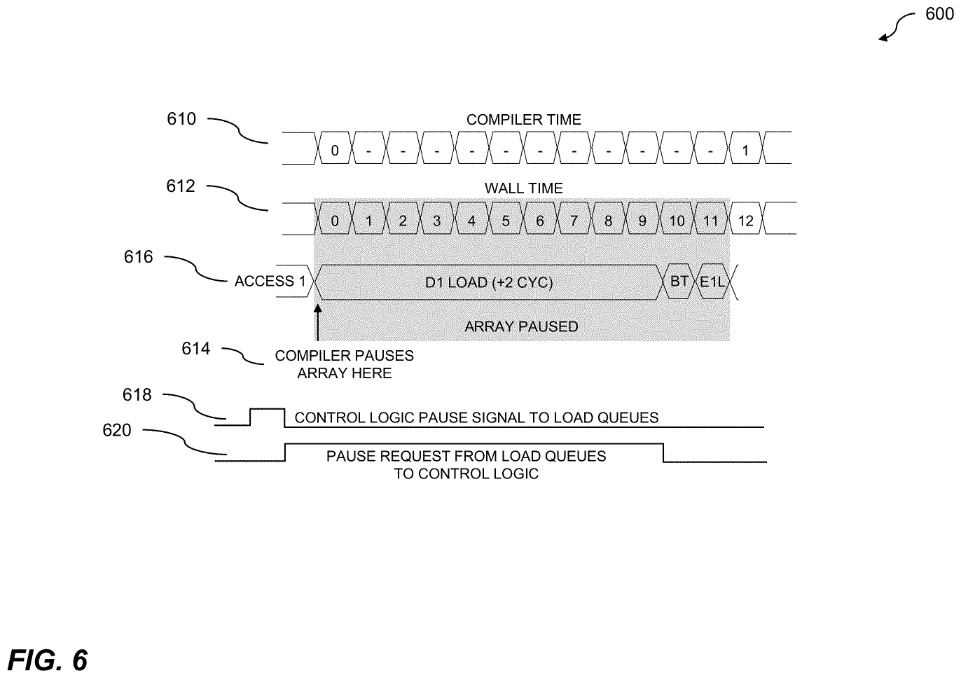

FIG. 6 shows virtual single cycle load latency. An array of compute elements can be known to a compiler, where the compiler can generate or compile code for the compute elements. The compiler can also direct communications to or from, between, and among compute elements, where the communications are used for data transfers. The data that is transferred can include one or more operands. The compiler can pause the compute elements, resume the compute elements, and the like. Since data can be transferred between a memory system and the compute elements of the array while the compute elements within the array are paused, and since pausing the compute elements can comprise a single compiler time step, the data transfers can appear to the compiler to have taken place within as few as a one compiler time step. The appearance of one compiler time step having transpired while the data transfers were being performed can appear as a virtual single cycle data load latency from the perspective of the compiler. A virtual single cycle load latency enables a parallel processing architecture with background loads. A two-dimensional (2D) array of compute elements is accessed, where each compute element within the array of compute elements is known to a compiler and is coupled to its neighboring compute elements. Operation of the array of compute elements is paused, and a bus coupling the array of compute elements to the memory system is repurposed. The repurposing couples one or more compute elements in the array of compute elements to the memory system, and a memory system operation is enabled during the pausing. Data is transferred from the memory system to the array of compute elements, using the bus that was repurposed.

Virtual single cycle load latency is shown 600. Time associated with a compiler, or “compiler time” 610, can show cycles, clock ticks, and so on. The compiler time shows a first cycle, a second cycle, and so on. Compiler time can include time that compute elements within the array of compute elements can be processing data. Compiler time can suspend when the array of compute elements is paused. In addition to compiler time, “wall time” 612 is shown. Wall time can include clock ticks, system cycles, system steps, and the like. Wall time can continue to advance while compiler time advances or can advance independently of compiler time. Wall time advancing independently of compiler time can occur while the array of compute elements is paused 614. Discussed throughout, while the array of compute elements is paused, data can be transferred 616 from a memory system to the array of compute elements. The data from the memory system can be transferred to a scratchpad memory in one or more compute elements within the two-dimensional array of compute elements. The pausing of the compute elements within the 2D array of compute elements can be accomplished using one or more control signals. The compiler can communicate with the load queues to indicate a type of load operation. A load operation can include a scheduled load operation, where data is transferred while the array of compute elements is operating. The control signal can include a control logic pause signal to the load queues 618. A load operation can also include a background load, where data is transferred while the compute elements are paused. The control signal can include a pause request from the load queues to control logic 620. A pause request can be generated based on an exception, where the exception can include a data cache miss. A data cache miss can be based on a data request for data that is not loaded in the data cache. When a data cache miss occurs, the missing data can be accessed from the memory system.

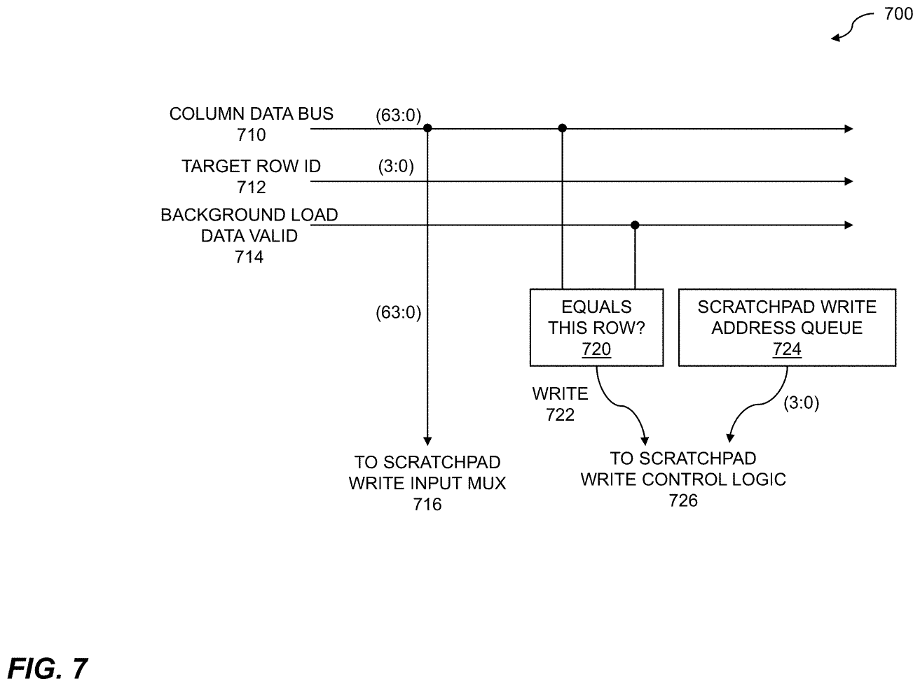

FIG. 7 illustrates logic for control background loads. A background load can be used to transfer or load data from a memory system into an array of compute elements for processing by the compute elements. A background load can occur while the array of compute elements is paused. Background loads enable a parallel processing architecture. A two-dimensional (2D) array of compute elements is accessed, where each compute element within the array of compute elements is known to a compiler and is coupled to its neighboring compute elements within the array of compute elements. Operation of the array of compute elements is paused, wherein the pausing occurs while a memory system continues operation. A bus coupling the array of compute elements is repurposed, wherein the repurposing couples one or more compute elements in the array of compute elements to the memory system, and wherein a memory system operation is enabled during the pausing. Data is transferred from the memory system to the array of compute elements, using the bus that was repurposed.

Example logic for control background loads is shown 700. A background load can be based on or controlled by a data “packet” 710. The packet can include data, where the data can be available on a bus. In the example, the data can include 64-bit data and can be available on a bus such as a column data bus. The packet can further include a target ID 712. The target ID can include a 4-bit target ID, where the target ID can be associated with a target row of compute elements within an array of compute elements. The packet can also include one or more control signals. In the example packet, a control signal can include a background load data valid signal 714. The data available on the 64-bit column data bus can be stored in one or more scratchpad memories. In embodiments, the one or more scratchpad memories can be accessible using a scratchpad write input mux 716. A particular scratchpad memory into which the data can be written can be logically evaluated 720. The logical evaluation can be based on determining whether the target row ID points to the row that includes a particular scratchpad memory and whether the background load data valid signal is indeed valid. The result of the logical evaluation 720 can be a write signal 722. Further to the target row ID and the background load data valid signal, a scratchpad write address queue value 724 can be provided. In embodiments, the scratchpad write address queue can include a 4-bit address. The write signal 722 and the scratchpad write address queue 724 can be provided to scratchpad write control logic 726. The scratchpad write control logic can control one or more queues, where the queues can buffer data transferred between the memory system and the compute elements of the array of compute elements.

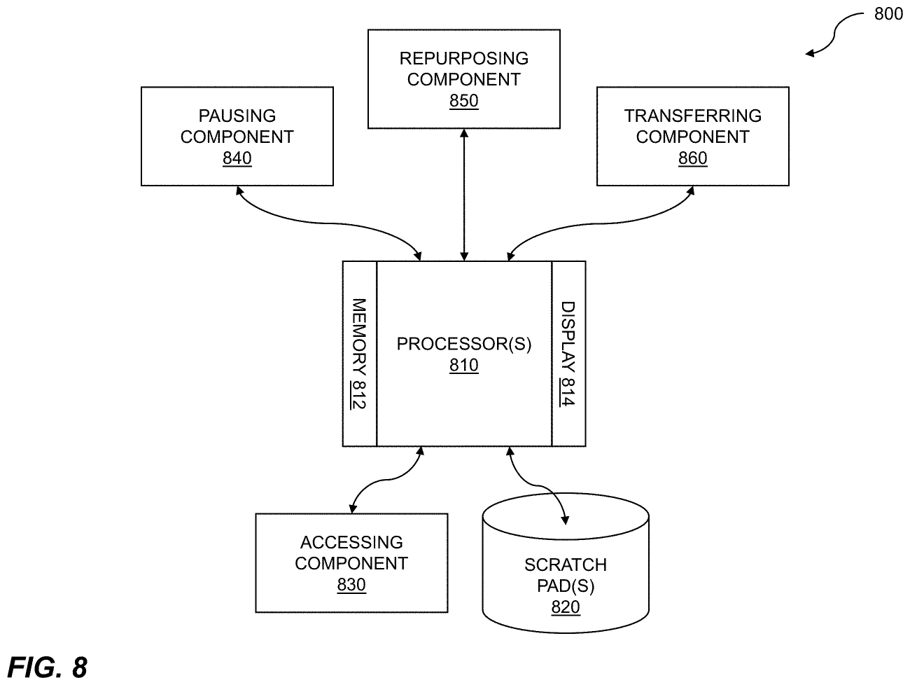

FIG. 8 is a system diagram for a parallel processing architecture with background loads. The parallel processing architecture with background loads enables task processing. The system 800 can include one or more processors 810, which are attached to a memory 812 which stores instructions. The system 800 can further include a display 814 coupled to the one or more processors 810 for displaying data; intermediate steps; control words; control words implementing Very Long Instruction Word (VLIW) functionality; topologies including systolic, vector, cyclic, spatial, streaming, or VLIW topologies; and so on. In embodiments, one or more processors 810 are coupled to the memory 812, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; pause operation of the array of compute elements, wherein the pausing occurs while a memory system continues operation; repurpose a bus coupling the array of compute elements, wherein the repurposing couples one or more compute elements in the array of compute elements to the memory system, and wherein a memory system operation is enabled during the pausing; and transfer data from the memory system to the array of compute elements, using the bus that was repurposed. The compute elements can include compute elements within one or more integrated circuits or chips, compute elements or cores configured within one or more programmable chips such as application specific integrated circuits (ASICs) or field programmable gate arrays (FPGAs), processors configured as a mesh, standalone processors, etc.

The system 800 can include one or more scratchpad memories 820. The one or more scratchpad memories 820 can be used to store data, control words, intermediate results, microcode, and so on. The scratchpad memory can be used for data transfer. In embodiments, the data from the memory system is transferred to a scratchpad memory in one or more compute elements within the two-dimensional array. A scratchpad memory can comprise a small, local, easily accessible memory available to a compute elements. In other embodiments, the scratchpad memory provides operand storage. Since a scratchpad memory is associated with a particular compute element, the compute element for which the contents of the scratchpad memory are intended can be identified. Further embodiments include tagging the data before it is transferred. The tagging can include a flag, an address, a code, and so on. In embodiments, the tagging can guide the transferring to a particular compute element within the array of compute elements. The tagging can be based on a location within the array. In embodiments, the tagging can include a target row location within the array of compute elements. The tagging can further include a target column location within the array of compute elements. The scratchpad memory can be accessible to one or more compute elements. In embodiments, the scratchpad memory can include a dual read, single write (2R1 W) scratchpad memory. That is, the 2R1 W scratchpad memory can enable two contemporaneous read operations and one write operation without the read and write operations interfering with one another.

The system 800 can include an accessing component 830. The accessing component 830 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage such as a scratchpad memory. The local storage may be accessible to more than one compute element indirectly, but it is generally associated with and only directly accessible by a particular compute element. Each compute element can communicate with neighbors, where the neighbors can include nearest neighbors or more remote “neighbors”. Communication between and among compute elements can be accomplished using a bus such as an industry standard bus, an on-chip bus such as a ring bus, a network such as a computer network, etc. In embodiments, the ring bus is implemented as a distributed multiplexor (MUX). The ring bus can be used to support various communication geometries within the array of compute elements such as a Manhattan communication geometry. In embodiments, the bus can include a bus, such as a ring bus, along a row or column of the array of compute elements.

The system 800 can include a pausing component 840. The pausing component 840 can include control and functions for pausing operation of the array of compute elements, wherein the pausing occurs while a memory system continues operation. The pausing operation can occur due to waiting for data such as operands to be processed by the compute elements. In embodiments, the pausing operation can be necessitated by an exception. An exception can include an arithmetic exception, waiting for data, waiting for an acknowledgement that data has been received, and the like. An exception can occur due to a data cache “miss”, where data needed for a computation by a compute element is neither available within a scratchpad associated with that compute element nor available in the data cache, which necessitates seeking the data from the memory system. In other embodiments, the pausing operation can be necessitated by data congestion. That is, one or more buses within the array of compute elements can become congested while trying to move data between memory system and the compute elements, between or among compute elements, etc. In embodiments, the data congestion can be due to access jitter. In embodiments, the data congestion can be due to a cache miss. The pausing operation of the array of compute elements can include storing a state of the compute elements within the array. Other components within the array of compute elements can continue operation during the pausing. In embodiments, the bus can continue operation during the pausing. The bus operation can include transferring data to one or more compute elements within the array of compute elements. The data can be transferred from the memory system to one or more compute elements. Further embodiments can include resuming operation of the array of compute elements after the transferring data is complete. Recall that load queues can be coupled between a memory system that can provide data, operands, and so on, and a bus that provides the operands to the compute elements within the array. In embodiments, the load queues can be notified of the pausing. Upon notification, the load queues can continue to provide data such as coefficients to compute elements, can flush their contents, etc.

The system 800 can include a repurposing component 850. The repurposing component 850 can include control logic and functions for repurposing a bus coupling the array of compute elements to the memory system for operation during the pausing. The repurposing of the bus can include placing the bus into a “pass through” mode in which the bus can continue operation during the pausing. Pass through mode may include saving the state currently on the bus to allow background load data to pass, and then restoring that saved data when the array resumes from the pause. A bus in a pass-through mode can be used for passing data between the memory system and one or more scratchpad memories, one or more queues, and so on. Further embodiments include load queues coupled between the memory system and the bus. The load queues can be used to hold or collect data from the memory system, to buffer the data, and so on. The system 800 can include a transferring component 860. The transferring component 860 can include control logic and functions for transferring data from the memory system to the array of compute elements, using the bus that was repurposed. The transferring data can include moving bytes, words, data blocks, and other amounts of data. The transferring data can be buffered. In embodiments, the transferring data from the memory system can buffered by the load queues. That is, the load queues can participate in the repurposing. Discussed throughout, the load queues can be used to accumulate data, to retime data transfers, etc. The buffers can be filled and emptied during a pause of the array of compute elements. In embodiments, the load queues can be emptied of the data that was buffered before a resume occurs. Recall that the data can be tagged before it is transferred between the memory system and the array of compute elements. In embodiments, the tagging can guide the transferring to a particular compute element within the array of compute elements. The tagging can serve as a compute element address, an identifier, and the like. In other embodiments, the pausing, the repurposing, and the transferring can comprise a background data load. A background data load can be used to provide data such as operands to one or more compute elements for other data arrives at the compute elements. The background data load can be used to anticipate outcomes of a branch or other control transfer operation.

The system 800 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; pausing operation of the array of compute elements, wherein the pausing occurs while a memory system continues operation; repurposing a bus coupling the array of compute elements, wherein the repurposing couples one or more compute elements in the array of compute elements to the memory system, and wherein a memory system operation is enabled during the pausing; and transferring data from the memory system to the array of compute elements, using the bus that was repurposed.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
pausing operation of the array of compute elements, wherein the pausing occurs while a memory system continues operation;
repurposing a bus coupling the array of compute elements, wherein the repurposing couples one or more compute elements in the array of compute elements to the memory system, and wherein a memory system operation is enabled during the pausing; and
transferring data from the memory system to the array of compute elements, using the bus that was repurposed.

2. The method of claim 1 wherein the data from the memory system is transferred to scratchpad memory in the one or more compute elements within the two-dimensional array.

3. The method of claim 2 wherein the scratchpad memory provides operand storage.

4. The method of claim 2 further comprising tagging the data before it is transferred.

5. The method of claim 4 wherein the tagging guides the transferring to a particular compute element within the array of compute elements.

6. The method of claim 4 wherein the tagging comprises a target row location within the array of compute elements.

7. The method of claim 1 wherein the bus comprises a ring bus along a row or column of the array of compute elements.

8. The method of claim 1 wherein the bus continues operation during the pausing.

9. The method of claim 1 further comprising resuming operation of the array of compute elements after the transferring data is complete.

10. The method of claim 9 wherein a compiled task determines the resuming operation.

11. The method of claim 1 further comprising load queues coupled between the memory system and the bus.

12. The method of claim 11 wherein the transferring data from the memory system is buffered by the load queues.

13. The method of claim 12 wherein the load queues are emptied of the data that was buffered before a resume occurs.

14. The method of claim 11 wherein the load queues participate in the repurposing.

15. The method of claim 11 wherein the load queues are notified of the pausing.

16. The method of claim 1 wherein the pausing operation is necessitated by an exception.

17. The method of claim 1 wherein the pausing operation is necessitated by data congestion.

18. The method of claim 17 wherein the data congestion is due to access jitter or a data cache miss.

19. The method of claim 1 wherein the pausing, the repurposing, and the transferring comprise a background data load.

20. The method of claim 1 wherein the compiler schedules computation in the array of compute elements.

21. The method of claim 20 wherein the computation includes compute element placement, results routing, and computation wave front propagation within the array of compute elements.

22. The method of claim 1 wherein a compiled task includes multiple programming loop instances circulating within the array of compute elements.

23. The method of claim 1 wherein the array of compute elements comprises a superstatic processor architecture.

24. The method of claim 1 wherein a compiled task comprises machine learning functionality.

25. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
pausing operation of the array of compute elements, wherein the pausing occurs while a memory system continues operation;
repurposing a bus coupling the array of compute elements, wherein the repurposing couples one or more compute elements in the array of compute elements to the memory system, and wherein a memory system operation is enabled during the pausing; and
transferring data from the memory system to the array of compute elements, using the bus that was repurposed.

26. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
pause operation of the array of compute elements, wherein the pausing occurs while a memory system continues operation;
repurpose a bus coupling the array of compute elements, wherein the repurposing couples one or more compute elements in the array of compute elements to the memory system, and wherein a memory system operation is enabled during the pausing; and
transfer data from the memory system to the array of compute elements, using the bus that was repurposed.
